(19) United States
(12) Patent Application Publication
(10) Pub. No.: US 2016/0054078 A1
(43) Pub. Date: Feb. 25, 2016

(54) PRE-COATED ALUMINUM SHEET AND HEAT SINK FOR ONBOARD LED LIGHTING

(71) Applicant: KABUSHIKI KAISHA KOBE SEIKO SHO( KOBE STEEL, LTD.), Hyogo (JP)

(72) Inventors: Nobuo HATTORI, Moka-shi (JP); Haruyuki KONISHI, Kobe-shi (JP); Kazunori KOBAYASHI, Moka-shi (JP); Daisuke KANEDA, Moka-shi (JP)

(73) Assignee: KABUSHIKI KAISHA KOBE SEIKO SHO( KOBE STEEL, LTD.), Kobe-shi, Hyogo (JP)

(21) Appl. No.: 14/779,456

(22) PCT Filed: Mar. 27, 2014
(86) PCT No.: PCT/JP2014/059040

§ 371 Date: Sep. 23, 2015

(30) Foreign Application Priority Data
Mar. 29, 2013 (JP) 2013-073266
Mar. 29, 2013 (JP) 2013-073268

(51) Int. Cl. F28F 13/18; F21V 29/70; F28F 21/08; F21V 29/89

(52) U.S. Cl. CPC F28F 13/18; F21V 29/89; F21V 29/70; F28F 21/084

(57) ABSTRACT

A pre-coated aluminum sheet (10), which is used in a heat sink (1), is characterized in that: an aluminum sheet (20) exhibits a thermal conductivity of equal to or greater than 150 W/m·K; a resin-based film (3) includes a thermosetting resin; the thickness of the resin-based film (3) is 15-200 μm; the integrated emissivity of the resin-based film (3) in the infrared region having the wavelength of 3-30 μm is equal to or greater than 0.80 at 25° C.; and, when the minimum temperature that the resin-based film (3) reaches while the heat sink (1) is used is expressed as T1° C., the glass transition temperature of the resin-based film (3) is equal to or below T1+20° C.

### TECHNICAL FIELD

The present invention relates to a heat sink for onboard LED lighting for mounting a light emission diode (LED) element thereon, and a pre-coated aluminum sheet used for the heat sink for onboard LED lighting.

### BACKGROUND ART

The lighting having a light emission diode (LED) element as a light emission source has started to penetrate the market gradually because of low power consumption and long life. Among the lighting, the onboard LED lighting such as a headlight of an automobile has especially got a lot of attention in recent years.

However, the LED element that is a light emission source of this LED lighting is very sensitive to heat, and has the problem that the light emission efficiency drops and the life thereof is affected when the temperature exceeds a permissible limit. In order to solve this problem, the heat in light emission of the LED element should be radiated to the surrounding space, and therefore a large heat sink is provided in the LED lighting.

For this heat sink for LED lighting, those made of an aluminum die-cast whose material is aluminum (including aluminum alloy) are commonly employed, and the heat sinks having typical configurations out of these heat sinks are disclosed in Patent Literatures 1-4.

### CITATION LIST

### Patent Literatures

[Patent Literature 1] Japanese Unexamined Patent Application Publication No. 2007-172932

[Patent Literature 2] Japanese Unexamined Patent Application Publication No. 2007-193960

[Patent Literature 3] Japanese Unexamined Patent Application Publication No. 2009-277535

[Patent Literature 4] Japanese Unexamined Patent Application Publication No. 2010-278350

### SUMMARY OF INVENTION

### Technical Problems

However, the heat sinks for onboard LED lighting of prior arts have following problems.

Firstly, there is a following problem.

Because the LED lighting repeats lighting-on and lighting-off in the use thereof, the difference in the thermal expansion between the heat sink and the LED element comes to be generated repeatedly. Also, because this difference in the thermal expansion is generated repeatedly, the adherence fatigue occurs in the adherence portion of the heat sink and the LED element, and there are cases that a gap is generated between the heat sink and the LED element and cracking is generated in the adherence portion of the LED element in the heat sink. Thus, there is a problem of deterioration of durability of the LED lighting.

Also, secondly, there is a following problem.

In operating a vehicle, vibration is normally generated in the vehicle. Also, by that the vibration is continuously generated during operation, there are cases that a gap is generated between the heat sink and the LED element and cracking is generated in the adherence portion of the LED element in the heat sink. Thus, there is a problem of deterioration of durability of the LED lighting.

Also, because the heat radiation property is required for the heat sink for onboard LED lighting, further improvement of the heat radiation property is required.

Furthermore, the heat sink for onboard LED lighting made of an aluminum die-cast of a prior art has the problem of low productivity and increased cost, and continuous pressing work using a sheet is required. Normally, an aluminum alloy for a die-cast is disadvantageous in the heat radiation performance in terms of low thermal conductivity compared to a wrought aluminum alloy, there is a limit in formation of thin thickness that becomes effective in weight reduction, and therefore sheet-make is expected also from these points.

The present invention is to solve the problems described above, and its object is to provide a pre-coated aluminum sheet and a heat sink for onboard LED lighting which firstly are excellent in the heat radiation property and can suppress the adherence fatigue of the adherence portion of the heat sink and the LED element.

Also, the present invention is to solve the problems described above, and its object is to provide a pre-coated aluminum sheet and a heat sink for onboard LED lighting which secondly are excellent in the heat radiation property and can improve the durability of the LED lighting by exhibiting the damping property.

### Solution to Problems

In order to solve the problems described above, the pre-coated aluminum sheet related to the first invention is a pre-coated aluminum sheet used for a heat sink for onboard LED lighting (hereinafter referred to as a heat sink when it is appropriate) including an aluminum sheet and a resin-based film (hereinafter referred to as a film when it is appropriate) formed on the surface of the aluminum sheet, in which the thermal conductivity of the aluminum sheet is equal to or greater than 150 W/m·K, the resin-based film includes a thermosetting resin, the film thickness of the resin-based film is 15-200 μm, the integrated emissivity of the resin-based film in the infrared region having the wavelength of 3-30 μm is equal to or greater than 0.80 at 25° C., and, when the minimum temperature that the resin-based film reaches while the heat sink for onboard LED lighting is used is expressed as T1° C., the glass transition temperature of the resin-based film is equal to or below T1+20° C.

According to such a configuration, because the thermal conductivity of the aluminum sheet is equal to or greater than 150 W/m·K, the heat radiation property of the heat sink using this pre-coated aluminum sheet is secured. Also, because the film having a cushion property is formed by specifying the resin kind, film thickness and glass transition temperature of the film to a predetermined range, the adherence fatigue durability of the adherence part of the heat sink and the LED element is secured. Further, by specifying the integrated emissivity of the film, the heat radiation property of the heat sink improves.

Also, in order to solve the problems described above, the pre-coated aluminum sheet related to the second invention is a pre-coated aluminum sheet used for a heat sink for onboard LED lighting including an aluminum sheet and a resin-based film formed on the surface of the aluminum sheet, in which the thermal conductivity of the aluminum sheet is equal to or greater than 150 W/m·K, the resin-based film includes a thermosetting resin, the film thickness of the resin-based film is 15-200 μm, the integrated emissivity of the resin-based film in the infrared region having the wavelength of 3-30 μm is equal to or greater than 0.80 at 25° C., and, when the minimum temperature that the resin-based film reaches while the heat sink for onboard LED lighting is used is expressed as T1° C. and the maximum temperature that the resin-based film reaches whilst the heat sink for onboard LED lighting is used is expressed as T2° C., the glass transition temperature of the resin-based film is {(T1+T2)/2−30}° C. to {(T1+T2)/2+30}° C.

According to such a configuration, because the thermal conductivity of the aluminum sheet is equal to or greater than 150 W/m·K, the heat radiation property of the heat sink using this pre-coated aluminum sheet is secured. Also, the damping property is secured by specifying the resin kind, film thickness and glass transition temperature of the film to a predetermined range, and, as a result, the durability of the LED lighting can be improved. Further, by specifying the integrated emissivity of the film, the heat radiation property of the heat sink improves.

With respect to the pre-coated aluminum sheet related to the first invention, it is preferable that the glass transition temperature of the resin-based film is equal to or below 10° C.

According to such a configuration, the film becomes rubber-like in most use environments with the exception of an extremely harsh environment.

With respect to the pre-coated aluminum sheet related to the second invention, it is preferable that the glass transition temperature of the resin-based film is 10° C. to 70° C.

According to such a configuration, the film becomes a state of capable of effectively absorbing the vibration energy in most use environments with the exception of such an environment that the temperature is extremely low or high, and the damping property is secured.

With respect to the pre-coated aluminum sheet related to the first and second inventions, it is preferable that the resin-based film further includes a black pigment composition.

According to such a configuration, the color tone of the film becomes black, and the heat radiation property of the heat sink further improves.

With respect to the pre-coated aluminum sheet related to the first and second inventions, it is preferable that the film thickness of the resin-based film is 15-50 μm.

According to such a configuration, in the first invention, economies further improve while maintaining the adherence fatigue durability of the adherence part of the heat sink and the LED element and the heat radiation property of the heat sink.

Also, according to such a configuration, in the second invention, economies further improve while maintaining the damping property and the heat radiation property of the heat sink.

With respect to the pre-coated aluminum sheet related to the first and second inventions, it is preferable that the crystal microstructure of the aluminum sheet is fibrous.

According to such a configuration, surface roughening in bending work becomes less, and the cracking is hardly generated in the coating film in bending work of the pre-coated aluminum sheet.

The heat sink for onboard LED lighting related to the first invention is a heat sink for onboard LED lighting including a heat sink formed body formed of wrought aluminum and aluminum alloy sheets (hereinafter referred to as an aluminum sheet when it is appropriate) and a resin-based film formed on the surface of the heat sink formed body, in which the thermal conductivity of the wrought aluminum and aluminum alloy sheets is equal to or greater than 150 W/m·K, the resin-based film includes a thermosetting resin, the film thickness of the resin-based film is 15-200 μm, the integrated emissivity of the resin-based film in the infrared region having the wavelength of 3-30 μm is equal to or greater than 0.80 at 25° C., and, when the minimum temperature that the resin-based film reaches while the heat sink for onboard LED lighting is used is expressed as T1° C., the glass transition temperature of the resin-based film is equal to or below T1+20° C.

According to such a configuration, because the thermal conductivity of the wrought aluminum and aluminum alloy sheets is equal to or greater than 150 W/m·K, the heat radiation property of the heat sink is secured. Also, because the film having a cushion property is formed by specifying the resin kind, film thickness and glass transition temperature of the film to a predetermined range, the adherence fatigue durability of the adherence part of the heat sink and the LED element is secured. Further, by specifying the integrated emissivity of the film, the heat radiation property of the heat sink improves.

The heat sink for onboard LED lighting related to the second invention is a heat sink for onboard LED lighting including a heat sink formed body formed of wrought aluminum and aluminum alloy sheets and a resin-based film formed on the surface of the heat sink formed body, in which the thermal conductivity of the wrought aluminum and aluminum alloy sheets is equal to or greater than 150 W/m·K, the resin-based film includes a thermosetting resin, the film thickness of the resin-based film is 15-200 μm, the integrated emissivity of the resin-based film in the infrared region having the wavelength of 3-30 μm is equal to or greater than 0.80 at 25° C., and, when the minimum temperature that the resin-based film reaches while the heat sink for onboard LED lighting is used is expressed as T1° C. and the maximum temperature that the resin-based film reaches while the heat sink for onboard LED lighting is used is expressed as T2° C., the glass transition temperature of the resin-based film is {(T1+T2)/2−30}° C. to {(T1+T2)/2+30}° C.

According to such a configuration, because the thermal conductivity of the wrought aluminum and aluminum alloy sheets is equal to or greater than 150 W/m·K, the heat radiation property of the heat sink is secured. Also, the damping property is secured by specifying the resin kind, film thickness and glass transition temperature of the film to a predetermined range, and, as a result, the durability of the LED lighting can be improved. Further, by specifying the integrated emissivity of the film, the heat radiation property of the heat sink improves.

With respect to the heat sink for onboard LED lighting related to the first invention, it is preferable that the glass transition temperature of the resin-based film is equal to or below 10° C.

According to such a configuration, the film becomes rubber-like in most use environments with the exception of an extremely harsh environment.

With respect to the heat sink for onboard LED lighting related to the second invention, it is preferable that the glass transition temperature of the resin-based film is 10° C. to 70° C.

According to such a configuration, the film becomes a state of capable of effectively absorbing the vibration energy in most use environments with the exception of such an environment that the temperature is extremely low or high, and the damping property is secured.

With respect to the heat sink for onboard LED lighting related to the first and second inventions, it is preferable that the resin-based film further includes a black pigment composition.

According to such a configuration, the color tone of the film becomes black, and the heat radiation property of the heat sink further improves.

With respect to the heat sink for onboard LED lighting related to the first and second inventions, it is preferable that the film thickness of the resin-based film is 15-50 μm.

According to such a configuration, in the first invention, economies further improve while maintaining the adherence fatigue durability of the adherence part of the heat sink and the LED element and the heat radiation property of the heat sink.

Also, according to such a configuration, in the second invention, economies further improve while maintaining the damping property and the heat radiation property of the heat sink.

### Advantageous Effects of Invention

The pre-coated aluminum sheet of the first invention is excellent in the heat radiation property. Also, because the adherence fatigue of the adherence portion of the heat sink and the LED element can be suppressed when used as the heat sink, the durability of the LED lighting can be improved.

The pre-coated aluminum sheet of the second invention is excellent in the heat radiation property. Also, because excellent damping property can be exhibited when used as the heat sink, the durability of the LED lighting can be improved.

The heat sink for onboard LED lighting of the first invention is excellent in the heat radiation property. Also, because the adherence fatigue of the adherence portion of the heat sink and the LED element can be suppressed, the durability of the LED lighting improves.

The heat sink for onboard LED lighting of the second invention is excellent in the heat radiation property. Also, because the damping property is excellent, the durability of the LED lighting improves.

### BRIEF DESCRIPTION OF DRAWINGS

FIG. 1A is a cross-sectional view schematically illustrating a configuration of the heat sink for onboard LED lighting related to the present invention.

FIG. 1B is a cross-sectional view schematically illustrating a configuration of the pre-coated aluminum sheet of the present invention.

### DESCRIPTION OF EMBODIMENTS

Below, embodiments of the present invention will be explained referring to the drawings.

### First Embodiment

### <<Heat Sink>>

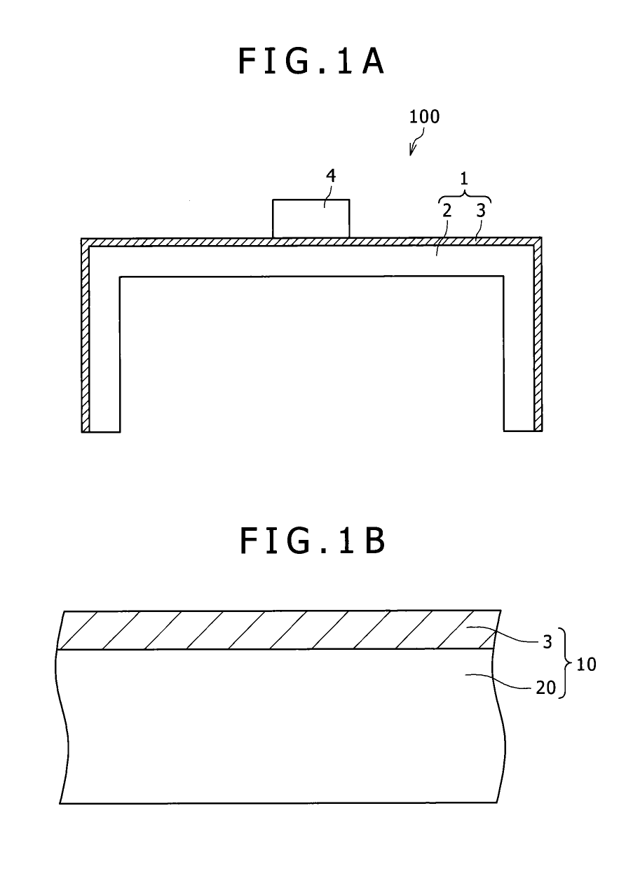

As illustrated in FIG. 1A, a heat sink 1 related to the present invention is used for an onboard LED lighting 100, and includes a heat sink formed body 2 formed of wrought aluminum and aluminum alloy sheets and a resin-based film 3 formed on the surface of the heat sink formed body 2. Also, with respect to the heat sink 1, the thermal conductivity of the wrought aluminum and aluminum alloy sheets and the composition, film thickness, integrated emissivity, and glass transition temperature of the resin-based film 3 are specified.

Below, each configuration will be explained.

### <Heat Sink Formed Body>

The heat sink formed body 2 is one formed of wrought aluminum and aluminum alloy sheets and made of an aluminum. The reason of specifying “wrought aluminum and aluminum alloy sheets” is to discriminate it against those made of an aluminum die-cast and resin and made of iron and other metals currently in use by limitation to the wrought aluminum and aluminum alloy sheets, and an aluminum sheet excellent in the productivity, pre-coating treatability and the like is preferable among the wrought aluminum and aluminum alloy sheets. Below, the aluminum sheet will be explained.

The aluminum sheet mentioned in the present invention is formed of aluminum or aluminum alloy, and the aluminum sheet (aluminum sheet or aluminum alloy sheet) used in the present invention is not particularly limited, and can be selected based on the product shape, forming method, strength required at the time of use, and the like. In general, as an aluminum sheet for press forming, a non-heat treatment type aluminum sheet that is 1000 series pure aluminum sheet for industrial use, 3000 series Al—Mn system alloy sheet, and 5000 series Al—Mg system alloy sheet, or a part of 6000 series Al—Mg—Si system alloy sheet which is a heat treatment type aluminum sheet are used. However, with respect to the heat sink formed body 2, because the thermal conductivity is made equal to or greater than 150 W/m·K as described below, the aluminum sheet is generally limited to 1000 series, a part of 3000 series, and a part of 6000 series.

The aluminum sheet is preferably 1000 series, and especially preferable composition is as follows.

### [Preferable Range of Si Content: 0.03-1.00 Mass %]

Si has an effect of being solid-solutionized in the base metal and increasing the strength of an aluminum alloy sheet, and the effect thereof improves as Si content increases. The effect thereof becomes more sufficient when Si content is equal to or greater than 0.03 mass %, and the thermal conductivity improves and the performance as a heat sink material improves when Si content is equal to or less than 1.00 mass %.

### [Preferable Range of Fe Content: 0.10-0.80 Mass %]

Fe has an effect of being solid-solutionized in the base metal and increasing the strength of an aluminum alloy sheet, and the effect thereof improves as Fe content increases. The effect thereof becomes more sufficient when Fe content is equal to or greater than 0.10 mass %, and the thermal conductivity improves and the performance as a heat sink material improves when Fe content is equal to or less than 0.80 mass %.

[Preferable Range of Cu Content: Equal to or Less than 0.30 Mass %]

Cu has an effect of being solid-solutionized in the base metal and increasing the strength of an aluminum alloy sheet, and the effect thereof improves as Cu content increases. The thermal conductivity improves and the performance as a heat sink material improves when Cu content is equal to or less than 0.30 mass %.

[Preferable Range of Mn Content: Equal to or Less than 0.20 Mass %]

Mn has an effect of being solid-solutionized in the base metal and increasing the strength of an aluminum alloy sheet, and the effect thereof improves as Mn content increases. The thermal conductivity improves and the performance as a heat sink material improves when Mn content is equal to or less than 0.20 mass %.

[Preferable Range of Mg Content: Equal to or Less than 0.20 Mass %]

Mg has an effect of being solid-solutionized in the base metal and increasing the strength of an aluminum alloy sheet, and the effect thereof improves as Mg content increases. The thermal conductivity improves and the performance as a heat sink material improves when Mg content is equal to or less than 0.20 mass %.

[Preferable Range of Cr Content: Equal to or Less than 0.10 Mass %]

Cr has an effect of being solid-solutionized in the base metal and increasing the strength of an aluminum alloy sheet, and the effect thereof improves as Cr content increases. The thermal conductivity improves and the performance as a heat sink material improves when Cr content is equal to or less than 0.10 mass %.

[Preferable Range of Zn Content: Equal to or Less than 0.20 Mass %]

Zn has an effect of being solid-solutionized in the base metal and increasing the strength of an aluminum alloy sheet, and the effect thereof improves as Zn content increases. The thermal conductivity improves and the performance as a heat sink material improves when Zn content is equal to or less than 0.20 mass %.

[Preferable Range of Ti Content: Equal to or Less than 0.10 Mass %]

Ti has an effect of miniaturizing and homogenizing (stabilizing) the aluminum alloy casting microstructure, and has an effect of preventing the casting crack in blooming the slab for rolling. When Ti content exceeds 0.10 mass %, the effect thereof saturates. Also, when Ti content is equal to or less than 0.10 mass %, the thermal conductivity improves. Therefore, containment exceeding 0.10 mass % is unnecessary.

With respect to the heat sink formed body 2, the thermal conductivity of the aluminum sheet is made equal to or greater than 150 W/m·K. With respect to the heat sink formed body 2, the heat radiation property is required because the application thereof is the heat sink 1. In order to secure desired heat radiation property in the present invention, the thermal conductivity of the heat sink formed body 2 that is the aluminum sheet forming the heat sink formed body 2 should be made equal to or greater than 150 W/m·K. Therefore, the thermal conductivity of the aluminum sheet is made equal to or greater than 150 W/m·K, preferably equal to or greater than 200 W/m·K. Further, although the upper limit value is not to be particularly stipulated, it is preferably equal to or less than 240 W/m·K from the economical viewpoint. As the aluminum alloy having such a property, the alloys with the predetermined series number and composition described above can be cited.

The thermal conductivity can be measured by the laser flash method for example.

Further, although the aluminum sheet used for the heat sink formed body 2 may be either the pre-coated material or the after-coated material, the pre-coated material is preferable from the economical viewpoint.

### <Resin-Based Film>

The resin-based film 3 is formed on the surface of the heat sink formed body 2, and improves the heat radiation property of the heat sink formed body 2 and the adherence fatigue durability of the adherence part of the LED element. Here, the surface means a face where the LED element is adhered to the heat sink formed body 2, and, with respect to the back surface, the film may be formed optionally according to the structure of the heat sink.

The resin-based film 3 includes a thermosetting resin. The thermosetting resin can be obtained by that two kinds or more selected from a polyester resin, epoxy resin, phenolic resin, melamine resin, urea resin, and acrylic resin for example are included, and that a hydroxyl group, carboxyl group, glycidyl group, amino group, isocyanate group and the like included in the both resins are made to form a combination for mutual chemical bonding. When two kinds or more of the resins of such a combination are included, because one resin and the other resin thermosettingly react with each other as a main agent and a setting agent, a thermosetting resin is formed. When the thermosetting reaction does not proceed sufficiently according to the combination, a setting agent such as an isocyanate compound may be combined separately.

When such resin is included alone (for example when a polyester resin is included alone), there is a case the film 3 is fused when the heat sink 1 is used, the adherence force of the heat sink 1 and an LED element 4 deteriorates in this case, and therefore the durability of the heat sink 1 deteriorates. However, even in the case of the single use, when a setting agent such as an isocyanate compound is combined separately, a thermosetting resin is formed.

Out of the combination of the films combining two kinds or more of the resin composition, when an amino-cured polyester-system resin, isocyanate-cured polyester-system resin, melamine-cured polyester-system resin, phenol-cured epoxy-system resin, urea-cured epoxy-system resin, and the like for example are utilized, the heat resistance and adhesion improve which is more preferable. Further, a modified resin such as an acrylic modified epoxy resin and a urethane modified polyester resin can be also suitably used.

### [Film Thickness]

The film thickness of the resin-based film 3 is made 15-200 μm. When the film thickness is less than 15 μm, the cushion property of the film 3 deteriorates, therefore, when the heat cycle is repeated, the adherence part of the heat sink 1 and the LED element 4 is liable to be subjected to thermal fatigue, and the durability of the heat sink 1 deteriorates. On the other hand, when the film thickness exceeds 200 μm, because the heat resistance of the coating film increases excessively, the heat radiation property of the heat sink 1 deteriorates. However, because the improvement effect of the cushion property and the integrated emissivity saturates in the range of exceeding 50 μm and equal to or less than 200 μm of the film thickness, it is preferable that the film thickness is 15-50 μm from the economical viewpoint.

With respect to the measuring method of the film thickness of the resin-based film 3, measurement is possible by an eddy current film thickness meter ISOSCOPE® for example.

### [Integrated Emissivity]

In the present invention, the integrated emissivity of the resin-based film 3 in the infrared region having the wavelength of 3-30 μm is to be equal to or greater than 0.80 at 25° C. The emissivity is a proportional factor obtained by dividing the infrared radioactivity from the object surface by the infrared radioactivity from the black body surface, and is defined with respect to the light with a predetermined wavelength in a predetermined temperature. The possible numerical value is within the range from 0 (white body) to 1 (black body), and, as the number is larger, the infrared radioactivity is larger. The result obtained by integrating it over the wavelength region of a certain range is the integrated emissivity. According to Planck's radiation formula, the wavelength of the infrared possibly generated at a temperature near the room temperature which is the implemented temperature of the present invention, or more specifically the actual use temperature range of 0-100° C., is concentrated to the range of 3-30 μm of the wavelength region. In other words, the infrared of the wavelength region deviating from the range of this wavelength region can be ignored. By such reason, in the present invention, limitation is made to the infrared of the wavelength region of 3-30 μm at 25° C.

When the integrated emissivity of the infrared having the wavelength of 3-30 μm with respect to the resin-based film 3 is less than 0.80 at 25° C., the capacity of emitting the heat as the infrared from the surface of the resin-based film 3 deteriorates, and the capacity of cooling the product becomes insufficient. Therefore, the heat radiation property of the heat sink 1 deteriorates. Also, the integrated emissivity of the infrared described above is preferably equal to or greater than 0.85, and more preferably equal to or greater than 0.90. Further, although the upper limit value is not particularly stipulated, it is preferable to be equal to or less than 0.99 from the economical viewpoint. The integrated emissivity of the infrared having the wavelength of 3-30 μm can be controlled by combination of the color of the film, the film thickness, the kind of film, and the like.

The integrated emissivity of the infrared having the wavelength of 3-30 μm with respect to the resin-based film 3 can be measured using a simplified emissivity meter available in the market, and can be measured using a Fourier transform infrared spectrophotometer (FTIR) and the like. More specifically, the measured value obtained using the emissivity meter apparatus D&S AERD made by Kyoto Electronics Manufacturing Co., Ltd. can be employed.

### [Glass Transition Temperature of Resin-Based Film]

When the minimum temperature that the resin-based film 3 reaches while the heat sink 1 is used is expressed as T1° C., the glass transition temperature of the resin-based film 3 is to be equal to or below T1+20° C.

The glass transition temperature is one of the transition temperature of a resin, the resin of a temperature equal to or above the glass transition temperature is supposed to be soft-rubber-like in general, and the resin of a temperature below the glass transition temperature is supposed to be hard-glass-like in general. Also, the glass transition temperature mentioned here means one measured by the differential scanning calorimetry method (DSC method).

Here, “the minimum temperature T1° C. that the resin-based film 3 reaches while the heat sink 1 is used” means a state of the lowest temperature in which the temperature of the use environment itself such as the night and the morning in the winter is low and there is no heat generation from the LED element 4 in the environment the onboard LED lighting 100 using the heat sink 1 is actually used. In other words, it means the lowest arrival temperature of the heat sink in a use environment of a temperature, with the heat sink 1 not being exposed to low temperature equal to or below the temperature.

In the present invention, although the cushion property of the resin-based film 3 in the portion where the LED element 4 and the heat sink 1 contact each other in the heat sink 1 is dealt with, however, when the glass transition temperature of the resin-based film 3 becomes equal to or below a temperature, with the heat sink 1 not being exposed to low temperature equal to or below the temperature, the resin-based film 3 becomes a high temperature state of equal to or above the glass transition temperature or a rubber-like state constantly in all use environment. Thus, the resin-based film 3 constantly becomes a state of soft and having high cushion property. In a state with high cushion property, when the heat cycle is repeated, the adherence part of the heat sink 1 and the LED element 4 is hardly subjected to thermal fatigue, and the durability of the heat sink 1 improves. However, practically, the polymer substance ranges in the molecular weight, the primary structure is not uniform such that a branching structure is generated within a molecule, and the high order structure such as the array of the molecules also cannot be deemed to be uniform at a micro level. The glass transition temperature is only a representative value, and the transition occurs gradually in a temperature range having a width of some degree. Also, because the actual automobile is designed according to the use environment to some degree such as “cold district specification”, even in a case the glass transition temperature exceeds T1, there is a case that excellent durability can be secured depending the environment. Therefore, in consideration of such actual situations, the glass transition temperature of the resin-based film 3 is to be made equal to or below T1+20° C. which adds a width of some degree to T1° C. that is the minimum temperature that the resin-based film 3 reaches while the heat sink 1 is used. The preferable range of the glass transition temperature of the resin-based film 3 is equal to or below T1° C., and more preferable range is equal to or below T1−10° C.

Because such temperature T1 is entirely different according to the nation and district where the onboard LED of the present invention is used, optimum one comes only to have to be selected according to the place. To be more specific, when the tropical district is assumed, the glass transition temperature of the resin-based film 3 is supposed to only have to be equal to or below T1+20=55° C. of the case of T1=35° C. However, because it is supposed to be preferable that possible largest numbers of the vehicles can be made the object, it is more preferable to be equal to or below 10° C. When the glass transition temperature of the resin-based film 3 is equal to or below 10° C., the resin-based film 3 becomes rubber-like in most use environments with the exception of an extremely harsh environment. Further, although the lower limit value is not particularly stipulated, it is more preferable to be equal to or above −40° C. The preferable range of the glass transition temperature is equal to or below 5° C. and equal to or above −20° C., and more preferably equal to or below 0° C. and equal to or above −10° C. The glass transition temperature mentioned here can be adjusted by changing the kind and combination of the resins forming the resin-based film 3 and the molecular structure of the resin.

It is preferable that the resin-based film 3 further includes the black pigment composition. By that the resin-based film 3 includes the black pigment composition, the color tone of the resin-based film 3 becomes black. Because the black color has high heat radiation property, the heat radiation property of the heat sink 1 improves further.

As the concrete examples of the black pigment composition, in addition to those of the carbon system such as the carbon black and graphite, the metal oxide system and the like of copper, manganese, iron and the like can be cited. It is preferable that the black pigment composition is added by 3-50 mass % to the resin material that forms the resin-based film 3.

### [Others]

With respect to the resin-based film 3, a coloring agent of a small amount and additives imparting various functions can be contained within a range the desired effect of the present invention is exerted. For example, in order to further improve the formability, one kind or two kinds or more of lubricants such as the polyethylene wax, carnauba wax, micro crystalline wax, lanolin, Teflon® wax, silicone-based wax, graphite-based lubricant, and molybdenum-based lubricant for example can be contained. Also, as the electro-conductive fine particles to impart the electro-conductivity aiming to secure the earthing required in the electronic devices and the like, one kind or two kinds or more of metal fine particles to begin with nickel fine particles, metal oxide fine particles, electro-conductive carbon, graphite, and the like for example can be contained. Further, when the antifouling property is required, the fluorine-based compound and silicone-based compound may be contained. Other than them, the antibacterial agent, antimold agent, deodorant, antioxidant, ultraviolet absorbent, antirust pigment, extender pigment, and the like may be contained provided that the desired effect of the present invention is exerted.

### <<Pre-Coated Aluminum Sheet>>

As illustrated in FIG. 1B, a pre-coated aluminum sheet 10 related to the present invention includes an aluminum sheet 20 and the resin-based film 3 formed on the surface of the aluminum sheet 20, and is used for the heat sink 1. Also, the thermal conductivity of the aluminum sheet 20 and the composition, film thickness, integrated emissivity, and glass transition temperature of the resin-based film 3 are stipulated.

Below, each configuration will be explained. Also, with respect to the portion common to that of the heat sink 1 of the present invention described above, explanation thereof will be omitted when it will be appropriate.

### <Aluminum Sheet>

The aluminum sheet 20 has the thermal conductivity equal to or greater than 150 W/m·K. The aluminum sheet 20 is generally limited to 1000 series, a part of 3000 series, and a part of 6000 series similarly to the aluminum sheet in the heat sink formed body 2.

With respect to the aluminum sheet 20, it is preferable that the crystal microstructure is fibrous. “Fibrous” means a state of having the elongated microstructure whose aspect ratio of the long axis direction and the short axis direction of the crystal microstructure is equal to or greater than 10 times.

When the crystal microstructure of the aluminum sheet 20 is fibrous, surface roughening in bending work becomes less. Here, in the case of the after-coated material, even when the surface is roughened, coating can be performed so as to cover the coating film from the top of the sheet, therefore such limitation is unnecessary, however, in the case of the pre-coated material, when surface roughening of the raw material of the bent part is much, there is a case that cracking is generated in the coating film. Therefore, with respect to the aluminum sheet 20, it is preferable that the crystal microstructure is fibrous.

Also, the crystal microstructure of the aluminum sheet can be discriminated by a microscope. When the crystal microstructure is discriminated by the microscope, the cross section of the aluminum which becomes parallel to the direction the aluminum is extended by rolling (rolling direction) is observed.

Next, preferable annealing condition for achieving the fibrous microstructure will be explained.

It is preferable that the annealing condition for achieving the fibrous microstructure and providing excellent bending workability is 130-280° C. and 1-10 hours. When the annealing temperature is below 130° C., the property varies within the aluminum coil annealed. On the other hand, when the annealing temperature exceeds 280° C., restoration and recrystallization progress, the proof stress drops, and the crystal grains are coarsened. Also, when the annealing time is less than 1 hour, the property within the aluminum coil varies similarly to the case the temperature is low. On the other hand, when the annealing time exceeds 10 hours, the factory productivity deteriorates.

### <Resin-Based Film>

The resin-based film 3 is formed on the surface of the aluminum sheet 20, and improves the heat radiation property of the heat sink formed body 2 and the adherence fatigue durability of the adherence part of the LED element. Here, the surface means a face where the LED element is adhered to the heat sink formed body 2, and, with respect to the back surface, the film may be formed optionally according to the structure of the heat sink.

The resin-based film 3 includes a thermosetting resin. The thermosetting resin can be obtained by that two kinds or more selected from a polyester resin, epoxy resin, phenolic resin, melamine resin, urea resin, and acrylic resin for example are included, and that a hydroxyl group, carboxyl group, glycidyl group, amino group, isocyanate group and the like included in the both resins are made to form a combination for mutual chemical bonding. Also, with respect to the film 3, the film thickness is 15-200 μm, and the integrated emissivity in the infrared region having the wavelength of 3-30 μm is equal to or greater than 0.80 at 25° C. Further, when the minimum temperature that the resin-based film 3 reaches while the heat sink 1 is used is expressed as T1° C., the glass transition temperature of the resin-based film 3 is to be equal to or below T1+20° C.

Because the resin-based film 3 is similar to the resin-based film 3 in the heat sink 1, explanation thereof will be omitted here.

### Second Embodiment

With respect to the second embodiment, only the positions different from the first embodiment will be explained.

### <<Heat Sink>>

As illustrated in FIG. 1A, a heat sink 1 related to the present invention is used for onboard LED lighting 100, and includes a heat sink formed body 2 formed of wrought aluminum and aluminum alloy sheets and a resin-based film 3 formed on the surface of the heat sink formed body 2. Also, with respect to the heat sink 1, the thermal conductivity of the wrought aluminum and aluminum alloy sheets and the composition, film thickness, integrated emissivity, and glass transition temperature of the resin-based film 3 are specified.

### <Resin-Based Film>

The resin-based film 3 is formed on the surface of the heat sink formed body 2, and improves the heat radiation property and the damping property of the heat sink formed body 2. Here, the surface means a face where the LED element is adhered to the heat sink formed body 2, and, with respect to the back surface, the film may be formed optionally according to the structure of the heat sink.

### [Film Thickness]

The film thickness of the resin-based film 3 is made 15-200 μm. When the film thickness is less than 15 μm, because the force the film 3 suppresses the vibration of the aluminum raw material when the vibration is applied to the heat sink 2 lowers, the damping property of the film 3 deteriorates. On the other hand, when the film thickness exceeds 200 μm, because the heat resistance of the coating film increases excessively, the heat radiation property of the heat sink 1 deteriorates. However, because the improvement effect of the damping property and the integrated emissivity saturates in the range of exceeding 50 μm and equal to or less than 200 μm of the film thickness, it is preferable that the film thickness is 15-50 μm from the economical viewpoint.

### [Glass Transition Temperature of Resin-Based Film]

When the minimum temperature that the resin-based film 3 reaches while the heat sink 1 is used is expressed as T1° C. and the maximum temperature that the resin-based film 3 reaches while the heat sink 1 is used is expressed as T2° C., the glass transition temperature of the resin-based film 3 is to be {(T1+T2)/2−30}° C. to {(T1+T2)/2+30}° C.

The glass transition temperature is one of the transition temperature of a resin, and the resin of a temperature near the glass transition temperature becomes a state significantly excellent in the damping property. Also, the glass transition temperature mentioned here means one measured by the differential scanning calorimetry method (DSC method).

Here, “the minimum temperature T1° C. that the resin-based film 3 reaches while the heat sink 1 is used” means a state of the lowest temperature in which the temperature of the use environment itself is low such as the night and the morning in the winter and there is no heat generation from the LED element 4 in the environment the onboard LED lighting 100 using the heat sink 1 is actually used. In other words, it means the lowest arrival temperature of the heat sink in a use environment of a temperature, with the heat sink 1 not being exposed to low temperature equal to or below the temperature.

Also, “the maximum temperature T2° C. that the resin-based film 3 reaches while the heat sink 1 is used” means a state of the highest temperature in which the temperature of the use environment itself is high such as the night time in summer and there is heat generation from the LED element 4 in the environment the onboard LED lighting 100 using the heat sink 1 is actually used. In other words, it means the highest arrival temperature of the heat sink in a use environment of a temperature, with the heat sink 1 not being exposed to high temperature equal to or above the temperature.

When the glass transition temperature is sufficiently high relative to the use environment temperature, the resin-based film 3 becomes excessively hard, therefore, when vibration is applied to the aluminum that forms the heat sink formed body 2, the resin-based film 3 also vibrates with same velocity of that of the aluminum, and therefore the damping property is spoiled. To the contrary, when the glass transition temperature is sufficiently low relative to the use environment temperature, the resin-based film 3 is excessively soft, therefore, when vibration is applied to the aluminum that forms the heat sink formed body 2, the force for suppressing the vibration of the resin-based film 3 is excessively weak, and the damping property is also spoiled. In order to exert the damping performance at the maximum, it is necessary that the resin-based film 3 has an appropriate hardness not excessively hard nor excessively soft.

When the glass transition temperature is stipulated so as to be a temperature near the middle temperature ({(T1+T2)/2° C.}) of the lowest arrival temperature T1° C. and the highest arrival temperature T2° C. while the heat sink 1 is used (the range of ±30° C.), the resin-based film 3 becomes a state of capable of exerting excellent damping property even when the vehicle is operated in the time of the daytime and the like when the LED element 4 is turned off not only in such night time as the LED element 4 is turned on. Therefore, the resin-based film 3 can appropriately absorb the vibration energy generated when the vehicle is operated in all time period, and becomes a state excellent in the damping property.

When the difference of the lowest arrival temperature T1° C. and the highest arrival temperature T2° C. while the heat sink 1 is used is little and when it is necessary to further ensure the damping property, the glass transition temperature of the resin-based film 3 is preferably {(T1+T2)/2−20}° C. to {(T1+T2)/2+20}° C., and more preferably {(T1+T2)/2−15}° C. to {(T1+T2)/2+15}° C.

Because such temperature T1 and T2 are entirely different according to the nation and district where the onboard LED of the present invention is used, optimum resin-based film 3 comes only to have to be selected according to the place. However, in order to cover possible greatest numbers of the vehicles, it is preferable to use the values of T1 and T2 in the region with high population and warm climate (the temperate zone and the like) as the representative values, and, to be more specific, it is preferable that the glass transition temperature of the resin-based film 3 is 10° C. to 70° C. When the glass transition temperature of the resin-based film 3 is 10° C. to 70° C., the film becomes a state of capable of effectively absorbing the vibration energy in most use environments with the exception of such environment that the temperature is extremely low or high. The range of the glass transition temperature is preferably 15° C. to 60° C., and more preferably 20° C. to 50° C. The glass transition temperature mentioned here can be adjusted by changing the kind and combination of the resins forming the resin-based film 3 and the molecular structure of the resin.

Other items of the resin-based film 3 are similar to those of the first embodiment.

### <<Pre-Coated Aluminum Sheet>>

As illustrated in FIG. 1B, a pre-coated aluminum sheet 10 related to the present invention includes an aluminum sheet 20 and the resin-based film 3 formed on the surface of the aluminum sheet 20, and is used for the heat sink 1. Also, the thermal conductivity of the aluminum sheet 20 and the composition, film thickness, integrated emissivity, and glass transition temperature of the resin-based film 3 are stipulated.

Further, with respect to the portion common to that of the heat sink 1 of the present invention described above, explanation thereof will be omitted when it will be appropriate.

### <Resin-Based Film>

The resin-based film 3 is formed on the surface of the aluminum sheet 20, and improves the heat radiation property of the heat sink formed body 2 and the damping property. Here, the surface means a face where the LED element is adhered to the heat sink formed body 2, and, with respect to the back surface, the film may be formed optionally according to the structure of the heat sink.

The resin-based film 3 includes a thermosetting resin. The thermosetting resin can be obtained by that two kinds or more selected from a polyester resin, epoxy resin, phenolic resin, melamine resin, urea resin, and acrylic resin for example are included, and that a hydroxyl group, carboxyl group, glycidyl group, amino group, isocyanate group and the like included in the both resins are made to form a combination for mutual chemical bonding. Also, with respect to the film 3, the film thickness is 15-200 μm, and the integrated emissivity in the infrared region having the wavelength of 3-30 μm is equal to or greater than 0.80 at 25° C. Further, when the minimum temperature that the resin-based film 3 reaches while the heat sink 1 is used is expressed as T1° C. and the maximum temperature that the resin-based film 3 reaches while the heat sink 1 is used is expressed as T2° C., the glass transition temperature of the resin-based film 3 is to be {(T1+T2)/2−30}° C. to {(T1+T2)/2+30}° C.

Because the resin-based film 3 is similar to the resin-based film 3 in the heat sink 1, explanation thereof will be omitted here.

Other items of the resin-based film 3 are similar to those of the first embodiment.

Although the first and second embodiments of the present invention have been explained above, the present invention is not to be limited to the embodiments described above, and can be changed within a range not departing from the range of the present invention.

For example, a pretreatment film (illustration thereof is omitted) may be arranged by pretreatment on the surface of the aluminum sheet 20.

### <Pretreatment>

In order to improve the adhesion with the resin-based film 3, it is preferable to subject the surface of the aluminum sheet 20 to pretreatment. With respect to preferable pretreatment, conventional known reaction type pretreatment film and spray type pretreatment film containing Cr, Zr, or Ti can be utilized. More specifically, the phosphoric acid chromate film, chromic acid chromate film, zirconium phosphate film, zirconium oxide film, titanium phosphate film, spray type chromate film, spray type zirconium film, and the like can be appropriately used. The pretreatment film of organic/inorganic hybrid type is also applicable in which an organic composition is combined to these films. Also, in recent years, hexavalent chromium tends to be hated in the trend of environmental responsiveness, and it is preferable to use the phosphoric acid chromate film, zirconium phosphate film, zirconium oxide film, titanium phosphate film, spray type zirconium film, and the like not containing hexavalent chromium.

Further, in the present invention, as the film thickness of the pretreatment film, the deposit of Cr, Zr, or Ti contained in the pretreatment film composition to the aluminum sheet 20 (metal Cr-, metal Zr-, or metal Ti-converted value) can be measured comparatively simply and quantitatively using conventional known fluorescent X-ray method. Therefore, the quality control of the pre-coated aluminum sheet 10 can be executed without impeding the productivity. Also, it is preferable that the deposit of the pretreatment film is 10-50 mg/m² in terms of the metal Cr-, metal Zr-, or metal Ti-converted value. When the deposit is equal to or greater than 10 mg/m², the entire surface of the aluminum sheet 20 can be coated uniformly, and the corrosion resistance improves. Also, when the deposit is equal to or less than 50 mg/m², the cracking is hardly generated in the film itself of the pretreatment in forming the pre-coated aluminum sheet 10.

Also, when the productivity is not considered, the surface of the aluminum sheet 20 can be subjected to conventional known treatment such as anodizing and electrolytic etching treatment. When these treatments are performed, because fine unevenness is formed on the surface of the aluminum sheet 20, the adhesion of the resin-based film 3 significantly improves.

Also, when the corrosion resistance is not required that much and it is intended to be done with a simple method, a method of subjecting the surface of the aluminum sheet 20 to degreasing treatment only is also acceptable. With respect to the method of degreasing, conventional known methods such as degreasing by organic system chemicals, degreasing by surfactant system chemicals, degreasing by alkaline system chemicals, and degreasing by acidic system chemicals can be employed. However, because the organic system chemicals and the surfactant system chemicals are inferior in the degreasing capacity a little bit, degreasing by alkaline system chemicals and acidic system chemicals is superior in the productivity. Although the degreasing capacity of the alkaline system chemicals can be controlled by the main composition, concentration, and treatment temperature of the alkali used, when the degreasing capacity is increased, smut is generated much, therefore, unless water washing thereafter is not performed sufficiently, there is also a case that the adhesion of the resin-based film 3 deteriorates adversely. Also, when a kind containing magnesium much as the additive element is used as the aluminum sheet 20, there is a case in the alkaline system chemicals that magnesium remains on the surface and the adhesion of the resin-based film 3 deteriorates. Therefore, in this case, it is preferable to use or jointly use the acidic system chemicals.

### <<Method for Manufacturing Pre-Coated Aluminum Sheet>>

Next, an example of the method for manufacturing the pre-coated aluminum sheet will be explained referring to FIG. 1 when it will be appropriate.

The method for manufacturing the pre-coated aluminum sheet 10 is not particularly limited, and the pre-coated aluminum sheet 10 can be obtained by spraying the coating material containing a resin that forms the base resin and the hardening agent on the aluminum sheet by conventional known method, and thereafter effecting the crosslinking reaction by heating. Also, it is preferable that the baking temperature in baking the coating material is made approximately 150° C. to 285° C.

Here, although the coating material can be sprayed by any means such as a brush, roll coater, curtain flow coater, roller curtain coater, electro-static coating machine, blade coater, and die coater, it is preferable to use the roll coater particularly in which the coating amount becomes uniform and the work is simple. When spraying is performed by the roll coater, although the film thickness of the resin-based film 3 is controlled by appropriately adjusting the convey speed of the aluminum sheet 20, the rotation direction and the rotation speed of the rolls, the pressing pressure (nip pressure) between the rolls, and the like, in ordinary cases, it is general that the thickness of the resin-based film 3 that can be sprayed by the spraying work of one time becomes 1-20 μm. In the present invention, the thickness of the resin-based film 3 is adjusted to 15-200 μm.

Also, when the heat sink 1 is to be manufactured using the pre-coated aluminum sheet 10, the pre-coated aluminum sheet 10 can be formed by folding work by a conventional known method, and can be formed into the shape of the heat sink 1.

### EXAMPLES

Next, the present invention will be explained specifically comparing the example satisfying the requirement of the present invention and the comparative example not satisfying the requirement of the present invention.

### First Example

In the present embodiment, simulated heat sinks for onboard LED lighting obtained by folding work of aluminum alloy sheets with different thermal conductivity and sheet thickness were manufactured, and “continuous lighting test” for confirming the heat radiation performance and “heat cycle test” assuming the adherence fatigue durability by thermal expansion and thermal shrinkage in repeating lighting-on and lighting-off were conducted.

An aluminum alloy with the composition illustrated in Table 1 was molten and casted to obtain an ingot, the ingot was subjected to facing, and was thereafter subjected to homogenizing heat treatment at 480° C. This homogenized ingot was subjected to hot rolling, cold rolling, and annealing treatment, and a rolled sheet with 1.0 mm sheet thickness was obtained. The rolling rate in the cold rolling was made 75%, and the annealing treatment was performed at 240° C. for 4 hours. A coating film was formed on the surface of this rolled sheet as explained below to obtain a test sample. The details will be given below.

TABLE 1
Composition (mass %)

| | | | | | | | | |
|---|---|---|---|---|---|---|---|---|
| Si | Fe | Cu | Mn | Mg | Cr | Zn | Ti | Remainder |

Alloy with thermal conductivity of 230 W/m · K

| | | | | | | | | |
|---|---|---|---|---|---|---|---|---|
| 0.10 | 0.30 | 0.02 | 0.01 | 0.02 | 0.01 | 0.01 | 0.01 | Al and |
| | | | | | | | | inevitable |
| | | | | | | | | impurities |

Alloy with thermal conductivity of 160 W/m · K

| | | | | | | | | |
|---|---|---|---|---|---|---|---|---|
| 0.25 | 0.45 | 0.20 | 1.10 | 1.20 | 0.02 | 0.20 | 0.03 | Al and |
| | | | | | | | | inevitable |
| | | | | | | | | impurities |

Alloy with thermal conductivity of 120 W/m · K

| | | | | | | | | |
|---|---|---|---|---|---|---|---|---|
| 0.10 | 0.20 | 0.04 | 0.35 | 4.55 | 0.02 | 0.02 | 0.01 | Al and |
| | | | | | | | | inevitable |
| | | | | | | | | impurities |

First, an LED lighting unit of 10 W available in the market was purchased and disassembled, and a heat sink made of a die-cast was taken out and was made a heat sink for the benchmark. Next, heat sinks made of an aluminum alloy sheet and becoming the example and the comparative example were manufactured simulating the shape of this heat sink for the benchmark. In simulating the shape, special attention was paid to truly reproduce at least the shapes of the LED element attaching part and the joining part that became necessary in reassembling into the LED lighting unit. The reason of doing so is that such shape with which assembling into the lighting unit before disassembling is impossible has no usability. Also, a shape that could be shaped from one sheet was employed considering the productivity.

The heat sink that became the example was manufactured as follows. First, the surface of the rolled sheet formed of the aluminum alloy having various sheet thickness and thermal conductivity was subjected to phosphoric acid chromate treatment after weak alkaline degreasing. Next, first, on the face of one side, a coating material becoming the composition described in the table of the example after heating was sprayed by a bar coater that would achieve the targeted thickness. Thereafter, temporary drying was performed at 100° C. for 60 s of the degree the crosslinking reaction was not promoted, and the coating material with the composition same with that for the first face was sprayed next on the opposite face by the same bar coater. By being heated thereafter with the baking temperature of 230° C. of the raw material arrival temperature and 60 s of the retention time in the furnace, the pre-coated aluminum sheet was manufactured. Also, the size of this pre-coated aluminum sheet was made 30 cm×30 cm, and the one obtained by folding work of it into a shape generally same with that of the heat sink made of a die-cast was used as the heat sink of the test material. In attaching the base plate of the LED element to the heat sink, bolts and nuts of M3 were used for fastening. Also, on the joining face of the base plate of the LED element and the heat sink, silicone grease available in the market was sprayed in order to increase the degree of the contact.

With respect to the heat sink of the comparative example also, one using a resin film was manufactured by a method similar to that for the example. However, with respect to one with the anodizing treatment, an aluminum sheet without any surface treatment was folded first into a predetermined shape, and was thereafter subjected to sulfuric acid anodizing. As the sulfuric acid anodizing condition, sulfuric acid was made 15%, and the voltage, current density, and exciting time were appropriately set to a condition with which a predetermined film thickness could be obtained. With respect to black anodizing in particular, after coloring by a black dye, sealing of anodic oxide coating was performed. Others are similar to the example. These test materials were measured and evaluated as follows.

### [Thermal Conductivity]

The thermal conductivity was measured by the laser flash method.

### [Integrated Emissivity]

The integrated emissivity was measured using the emissivity meter apparatus D&S AERD made by Kyoto Electronics Manufacturing Co., Ltd.

### [Film Thickness of Film]

The film thickness of the film was measured using the eddy current film thickness meter ISOSCOPE®.

### [Heat Radiation Property: Continuous Lighting Test]

Although use of the onboard LED lighting in various environments in the world can be assumed, the lighting is actually used only in the night time. In such condition, it is considered that the severest heat radiation property is required for the night time in the tropical zone. Therefore, assuming such environment, the continuous lighting test was conducted under the environment of 35° C.

The LED element of 10 W was attached to each heat sink of the benchmark, example, and comparative example and was made to emit light, and the temperature of the heat sink right below the LED element when the temperature reached a steady state was measured. At this time, the case the temperature was equal to or below that of the benchmark was determined to be excellent in the heat radiation property (excellent), and the case the temperature reached higher than that of the benchmark was determined to be poor in the heat radiation property (poor).

### [Adherence Fatigue Durability: Heat Cycle Test]

Out of the environment in which the onboard LED lighting is used, it is supposed that the lowest arrival time T1° C. falls on the time of lighting-off in the night time or morning in the winter. T1° C. is supposed to be generally same with the environment temperature because it is the time of lighting-off. Although the air temperature becomes approximately −40° C. in the polar zone, the air temperature becomes approximately 35° C. in the tropical zone to the contrary, and the use environment changes largely. Because it is supposed that the representative use environment of the automobile can be deemed to be the environment of the region where the population of the world is concentrated much, T1=10° C. assuming the temperate zone was made the representative value. Also, here, the adherence fatigue durability was made to be evaluated with the criterion of equal to or below 10° C. that was the more preferable glass transition temperature of the resin-based film.

As a result of confirmation using the heat sink of the benchmark, in this environment, the temperature of the heat sink in lighting-off was 10° C. that was same with T1, however, the temperature of the heat sink reached 60° C. in lighting-on. Therefore, simulating repetition of lighting-on and lighting-off, the thermal shock test of 10° C. and 60° C. was conducted. With respect to the heat cycle condition, repetition of being left at 10° C. for 1 hour and being left at 60° C. for 1 hour was made 1 cycle, and this was repeated by 3,000 cycles.

After the LED element was adhered to the respective heat sinks of the benchmark, example, and comparative example through the heat resistant grease, the thermal shock test was conducted, and the cycle number of times of the time when the LED element peeled off from the heat sink was measured. The case the cycle number of times was equal to or greater than that of the benchmark was deemed to be excellent in the durability of the adherence fatigue (excellent), and the case the cycle number of times was less than that of the benchmark was deemed to be poor in the durability (poor).

However, because the actual automobile is designed according to the use environment to some degree such as “cold district specification”, even when the durability described above may become (poor), there is a case that excellent durability can be secured depending on the environment. Therefore, with respect to those proved to be (poor) in the condition described above, the thermal shock test at T1=35° C. assuming the tropical zone was conducted additionally. As a result of confirmation using the heat sink of the benchmark, in this environment, although the heat sink at the time of lighting-off is 35° C., the heat sink at the time of lighting-on reaches 75° C. Therefore, in the additional test, the heat cycle test of 35° C. and 75° C. was conducted, the case the cycle number of times of the time when the LED element peeled off from the heat sink was equal to or greater than that of the benchmark was changed from (poor) to (fair) in the durability, and the case the cycle number of times was poorer than that of the benchmark was made to remain unchanged to be (poor) in the durability.

### [Weight Reduction]

This time, in changing the material of the die-cast heat sink that became the benchmark to a sheet, the target of the weight reduction was made 50% of the benchmark apart from the performance. Therefore, the case the weight of the heat sink of the example or the comparative example manufactured for trial was equal to or less than 50% of the benchmark was determined to be light in weight (excellent), and the case of exceeding 50% was determined to be not particularly light in weight but to have no problem in use (fair).

These results are illustrated in Table 2. Also, the underlined part in the table expresses that the requirement or the effect of the first invention was not satisfied nor exhibited.

TABLE 2

| | Raw material | | | | Film | | | | | |
|---|---|---|---|---|---|---|---|---|---|---|
| | thermal | Sheet | | Film | thick- | | | Heat | Adherence | Weight |
| | conductivity | thickness | | Tg | ness | | Integrated | radiation | fatigue | reduction |
| No. | (W/m · K) | (mm) | Film material | (° C.) | (μm) | Color | emissivity | property | durability | effect |
| 1 | 160 | 2 | Polyester•melamine | 10 | 15 | Black | 0.85 | Excellent | Excellent | Excellent |
| 2 | 230 | 2 | Polyester•melamine | 10 | 15 | Black | 0.85 | Excellent | Excellent | Excellent |
| 3 | 160 | 3 | Polyester•melamine | 10 | 15 | Black | 0.85 | Excellent | Excellent | Fair |
| 4 | 230 | 3 | Polyester•melamine | 10 | 15 | Black | 0.85 | Excellent | Excellent | Fair |
| 5 | 160 | 2 | Polyester•urea | 30 | 15 | Black | 0.85 | Excellent | Fair | Excellent |
| 6 | 160 | 2 | Polyester•melamine | 20 | 15 | Black | 0.85 | Excellent | Fair | Excellent |
| | | | epoxy | | | | | | | |
| 7 | 160 | 2 | Polyester•melamine | 30 | 15 | Black | 0.85 | Excellent | Fair | Excellent |
| | | | phenol | | | | | | | |
| 8 | 160 | 2 | Polyester•epoxy | 20 | 15 | Black | 0.85 | Excellent | Fair | Excellent |
| | | | acrylic | | | | | | | |
| 9 | 160 | 2 | Polyester•melamine | 10 | 50 | Black | 0.90 | Excellent | Excellent | Excellent |
| 10 | 160 | 2 | Polyester•melamine | 10 | 200 | Black | 0.90 | Excellent | Excellent | Excellent |
| 11 | 160 | 2 | Polyester•melamine | 10 | 15 | White | 0.80 | Excellent | Excellent | Excellent |
| 12 | 120 | 2 | Polyester•melamine | 10 | 15 | Black | 0.85 | Poor | Excellent | Excellent |
| 13 | 120 | 3 | Polyester•melamine | 10 | 15 | Black | 0.85 | Poor | Excellent | Fair |
| 14 | 160 | 2 | White anodic oxide film | — | 5 | White | 0.55 | Poor | Poor | Excellent |
| 15 | 160 | 2 | Black anodic oxide film | — | 20 | Black | 0.85 | Excellent | Poor | Excellent |
| 16 | 160 | 2 | Polyester•melamine | 10 | 5 | Black | 0.65 | Poor | Poor | Excellent |
| 17 | 160 | 2 | Epoxy•phenol | 75 | 15 | Black | 0.85 | Excellent | Poor | Excellent |
| 18 | 160 | 2 | Polyester•melamine | 10 | 300 | Black | 0.90 | Poor | Excellent | Excellent |
| 19 | 160 | 2 | Polyester•melamine | 10 | 10 | Black | 0.80 | Excellent | Poor | Excellent |
| 20 | 160 | 2 | Polyester•melamine | 10 | 15 | No color | 0.60 | Poor | Excellent | Excellent |
| 21 | 160 | 2 | Polyester only | 5 | 15 | Black | 0.80 | Excellent | Poor (fused) | Excellent |

As illustrated in Table 2, in Nos. 1-11, because the configuration of the first invention was satisfied, excellent result was secured. On the other hand, in Nos. 12-21, because the configuration of the first invention was not satisfied, the result became as follows.

In No. 12, because the thermal conductivity was less than the lower limit value, the heat radiation property was poor.

In No. 13, because the thermal conductivity was less than the lower limit value, the heat radiation property was poor.

In No. 14, because the material of the film was white anodic oxide film and the film thickness and the integrated emissivity were less than the lower limit value, the heat radiation property and the adherence fatigue durability were poor.

In No. 15, because the material of the film was white anodic oxide film, the adherence fatigue durability was poor.

In No. 16, because the film thickness and the integrated emissivity were less than the lower limit value, the heat radiation property and the adherence fatigue durability were poor.

In No. 17, because the glass transition temperature of the film did not satisfy the stipulation, the adherence fatigue durability was poor.

In No. 18, because the film thickness exceeded the upper limit value, the heat radiation property was poor.

In No. 19, because the film thickness was less than the lower limit value, the adherence fatigue durability was poor.

In No. 20, because the integrated emissivity was less than the lower limit value, the heat radiation property was poor.

In No. 21, because the material of the film was polyester only, the test material fused in the heat cycle test.

Further, all of the LED heat sinks described in Patent Literatures 1-4 are the inventions in which the shape having the fins is indispensable or recommendable, the die cast method is the must in order to achieve these shapes with aluminum, and they correspond to the benchmark heat sink in the first invention. The alloy for casting used for the die cast method is basically low in thermal conductivity and hard to reduce the weight, and therefore does not satisfy the first invention. Also, there is no description on the surface in all of the heat sinks, and no consideration is paid to the adherence durability of the LED element and the heat sink which is a feature of the first invention.

As illustrated in the present embodiment, this aluminum sheet of the prior art does not satisfy a constant level in the evaluation described above. Therefore, it was clarified objectively by the present example that the aluminum sheet related to the first invention was superior compared to the aluminum sheet of the prior art.

### Second Embodiment

In the present embodiment, simulated heat sinks for onboard LED lighting obtained by folding work of aluminum sheets with different thermal conductivity and sheet thickness were manufactured, and “continuous lighting test” for confirming the heat radiation performance and “vibration excitation test” assuming the damping property at the time of operating the vehicle were executed.

The test samples of the benchmark, example, and comparative example were manufactured by the method similar to that of the first embodiment.

These test materials were measured and evaluated as follows.

### [Thermal Conductivity]

The thermal conductivity was measured by the laser flash method.

### [Integrated Emissivity]

The integrated emissivity was measured using the emissivity meter apparatus D&S AERD made by Kyoto Electronics Manufacturing Co., Ltd.

### [Film Thickness of Film]

The film thickness of the film was measured using the eddy current film thickness meter ISOSCOPE®.

### [Heat Radiation Property: Continuous Lighting Test]

Although use of the onboard LED lighting in various environments in the world can be assumed, the lighting is actually used only in the night time. In such condition, it is considered that the severest heat radiation property is required for the night time in the tropical zone. Therefore, assuming such environment, the continuous lighting test was conducted under the environment of 35° C.

The LED element of 10 W was attached to each heat sink of the benchmark, example, and comparative example and was made to emit light, and the temperature of the heat sink right below the LED element when the temperature reached a steady state was measured. At this time, the case the temperature was equal to or below that of the benchmark was deemed to be excellent in the heat radiation property (excellent), and the case the temperature reached higher than that of the benchmark was deemed to be poor in the heat radiation property (poor).

### [Damping Property (Durability): Vibration Excitation Test]

The onboard LED lighting receives vibration during operation. In the use environment when considered so as to exclude the time during parking when vibration is not received, the lowest arrival temperature (T1° C.) of the LED lighting is supposed to fall in the time of lighting-off in the night time and morning of the winter. Here, although T1 becomes approximately −40° C. in the arctic/subarctic zone, T1 becomes approximately 35° C. in the tropical zone to the contrary, and therefore, the value of T1 largely differs according to the use environment. Further, although the highest arrival temperature (T2° C.) of the LED lighting is supposed to fall in the time of lighting-on in the night time of the summer, the value of T2 also largely differs according to the use environment similarly to T1.

However, because it was supposed that the representative use environment of the automobile could be judged to be the environment of the temperate zone which was the region where the population of the world was concentrated much, with respect to T1, T1=10° C. assuming the air temperature at early in the morning of the winter of the temperate zone was made the representative value. On the other hand, with respect to T2 also, assuming the temperate zone, the temperature of the time when The LED element was lit using the heat sink for the benchmark at the environment of 25° C. was confirmed, and, as a result, T2=70° C. was made the representative value.

Also, the heat sink lowest arrival temperature T1 and highest arrival temperature T2, as well as the early morning air temperature T3 in the winter, night time air temperature T4 in the summer, and the standard temperature T5 which become the premises for them in the temperate zone, arctic/subarctic zone, and tropical zone are illustrated in Table 3.

TABLE 3

| | Temperate | Arctic/subarctic | Tropical |
|---|---|---|---|
| | zone | zone | zone |
| Heat sink lowest arrival | 10 | −40 | 35 |
| temperature T1 (° C.) | | | |
| Heat sink highest arrival | 70 | 60 | 75 |
| temperature T2 (° C.) | | | |
| [(T1 + T2)/2 − 30]~[(T1 + | 10~70 | −20~40 | 25~85 |
| T2)/2 + 30] (° C.) | | | |
| Winter early morning air | 10 | −40 | 35 |
| temperature T3 (° C.) | | | |
| Summer night time air | 25 | 15 | 35 |
| temperature T4 (° C.) | | | |
| Standard air temperature T5 (° C.) | 25 | 10 | 35 |

With respect to the vibration excitation test, the test was conducted in accordance with the vibration durability testing method described in “Vibration testing methods for automobile parts” of JIS D 1601. Also, the testing condition was the condition according to the kind 1 and the kind B. Further, the testing temperature was made 25° C. which was the standard air temperature of the temperate zone.

After the LED element was adhered to the respective heat sinks of the benchmark, example, and comparative example through the heat resistant grease, the vibration excitation test was conducted, and the cycle number of times of the time when the LED element peeled off from the heat sink was measured. The case the cycle number of times was equal to or greater than that of the benchmark was deemed to be excellent in the durability (excellent), and the case the cycle number of times was less than that of the benchmark was deemed to be poor in the durability (poor).

However, because the actual automobile is designed according to the use environment to some degree such as “cold district specification”, even when the durability described above may become (poor), there is a case that excellent durability can be secured depending on the environment. Therefore, with respect to those proved to be (poor) in the condition described above, the vibration excitation test was conducted additionally at 35° C. assuming the tropical zone and 10° C. assuming the arctic/subarctic zone.

The case the cycle number of times of the time when the LED element peeled off from the heat sink in either of the conditions was equal to or greater than that of the benchmark was changed from (poor) to (fair) in the durability, and the case the cycle number of times was poorer than that of the benchmark in both cases was made to remain unchanged to be (poor) in the durability.

### [Weight Reduction]

This time, in changing the material of the die-cast heat sink that became the benchmark to a sheet, the target of the weight reduction was made 50% of the benchmark apart from the performance. Therefore, the case the weight of the heat sink of the example or the comparative example manufactured for trial was equal to or less than 50% of the benchmark was deemed to be light in weight (excellent), and the case of exceeding 50% was deemed to be not particularly light in weight but to have no problem in use (fair).

These results are illustrated in Table 4. Also, the underlined part in the table expresses that the requirement or the effect of the second invention was not satisfied nor exhibited.

TABLE 4

| | Raw material | | | | | | | | | |
|---|---|---|---|---|---|---|---|---|---|---|
| | thermal | Sheet | | Film | Film | | | Heat | | Weight |
| | conductivity | thickness | | Tg | thickness | | Integrated | radiation | | reduction |
| No. | (W/m · K) | (mm) | Film material | (° C.) | (μm) | Color | emissivity | property | Durability | effect |
| 101 | 160 | 2 | Polyester•urea | 30 | 15 | Black | 0.85 | Excellent | Excellent | Excellent |
| 102 | 230 | 2 | Polyester•urea | 30 | 15 | Black | 0.85 | Excellent | Excellent | Excellent |
| 103 | 160 | 3 | Polyester•urea | 30 | 15 | Black | 0.85 | Excellent | Excellent | Fair |
| 104 | 230 | 3 | Polyester•urea | 30 | 15 | Black | 0.85 | Excellent | Excellent | Fair |
| 105 | 160 | 2 | Polyester•melamine | 10 | 15 | Black | 0.85 | Excellent | Excellent | Excellent |
| 106 | 160 | 2 | Polyester•melamine | 20 | 15 | Black | 0.85 | Excellent | Excellent | Excellent |
| | | | epoxy | | | | | | | |
| 107 | 160 | 2 | Epoxy•phenol | 75 | 15 | Black | 0.85 | Excellent | Fair | Excellent |
| 108 | 160 | 2 | Polyester•epoxy | 20 | 15 | Black | 0.85 | Excellent | Excellent | Excellent |
| | | | acrylic | | | | | | | |
| 109 | 160 | 2 | Polyester•urea | 30 | 50 | Black | 0.90 | Excellent | Excellent | Excellent |
| 110 | 160 | 2 | Polyester•urea | 30 | 200 | Black | 0.90 | Excellent | Excellent | Excellent |
| 111 | 160 | 2 | Polyester•urea | 30 | 15 | White | 0.80 | Excellent | Excellent | Excellent |
| 112 | 120 | 2 | Polyester•urea | 30 | 15 | Black | 0.85 | Poor | Excellent | Excellent |
| 113 | 120 | 3 | Polyester•urea | 30 | 15 | Black | 0.85 | Poor | Excellent | Fair |
| 114 | 160 | 2 | White anodic oxide | — | 5 | White | 0.55 | Poor | Poor | Excellent |
| 115 | 160 | 2 | Black anodic oxide | — | 20 | Black | 0.85 | Excellent | Poor | Excellent |
| 116 | 160 | 2 | Polyester•urea | 30 | 5 | Black | 0.65 | Poor | Poor | Excellent |
| 117 | 160 | 2 | Epoxy•urea | 95 | 15 | Black | 0.85 | Excellent | Poor | Excellent |
| 118 | 160 | 2 | Polyester•urea | 30 | 300 | Black | 0.90 | Poor | Excellent | Excellent |
| 119 | 160 | 2 | Polyester•urea | 30 | 10 | Black | 0.80 | Excellent | Poor | Excellent |
| 120 | 160 | 2 | Polyester•urea | 30 | 15 | No color | 0.60 | Poor | Excellent | Excellent |
| 121 | 160 | 2 | Polyester only | 5 | 15 | Black | 0.85 | Excellent | Poor (fused) | Excellent |

As illustrated in Table 4, in Nos. 101-111, because the configuration of the second invention was satisfied, excellent result was secured. Also, with respect to No. 107, the glass transition temperature of the film was slightly high and excellent result was not secured in the vibration excitation test assuming the temperate zone, however, excellent result was secured in the vibration excitation test assuming the tropical zone.

On the other hand, in Nos. 112-121, because the configuration of the second invention was not satisfied, the result became as follows.

In No. 112, because the thermal conductivity was less than the lower limit value, the heat radiation property was poor.

In No. 113, because the thermal conductivity was less than the lower limit value, the heat radiation property was poor.

In No. 114, because the material of the film was white anodic oxide film and the film thickness and the integrated emissivity were less than the lower limit value, the heat radiation property and the durability were poor.

In No. 115, because the material of the film was white anodic oxide film, the durability was poor.

In No. 116, because the film thickness and the integrated emissivity were less than the lower limit value, the heat radiation property and the durability were poor.

In No. 117, because the glass transition temperature of the film did not satisfy the stipulation, the durability was poor.

In No. 118, because the film thickness exceeded the upper limit value, the heat radiation property was poor.

In No. 119, because the film thickness was less than the lower limit value, the durability was poor.

In No. 120, because the integrated emissivity was less than the lower limit value, the heat radiation property was poor.

In No. 121, because the material of the film was polyester only, the test material fused in the heat cycle test.

Further, all of the LED heat sinks described in Patent Literatures 1-4 are the inventions in which the shape having the fins is indispensable or recommendable, the die cast method is the must in order to achieve these shapes with aluminum, and they correspond to the benchmark heat sink in the second invention. The alloy for casting used for the die cast method is basically low in thermal conductivity and hard to reduce the weight, and therefore does not satisfy the second invention. Also, there is no description on the surface in all of the heat sinks, and no consideration is paid to the damping property which is a feature of the second invention.

As illustrated in the present embodiment, this aluminum sheet of the prior art does not satisfy a constant level in the evaluation described above. Therefore, it was clarified objectively by the present example that the aluminum sheet related to the second invention was superior compared to the aluminum sheet of the prior art.

Although the present invention has been explained in detail above illustrating the embodiments and examples, the purport of the present invention is not limited to the contents described above, and the range of the right thereof should be interpreted based on the description of the claims. Also, it is needless to mention that the contents of the present invention can be amended, changed, and so on based on the description described above.

The present application is based on the Japanese Patent Application (No. 2013-073266) applied on Mar. 29, 2013 and the Japanese Patent Application (No. 2013-073268) applied on Mar. 29, 2013, and the contents thereof are incorporated by reference into the present application.

### INDUSTRIAL APPLICABILITY

The present invention is useful for a heat sink for onboard LED Lighting.

### REFERENCE SIGNS LIST

1: Heat sink for onboard LED Lighting
2: Heat sink formed body
3: Resin-based film
4: LED element
10: Pre-coated aluminum sheet
20: Aluminum sheet
100: Onboard LED lighting

1. A pre-coated aluminum sheet comprising:
an aluminum sheet; and
a resin-based film formed on the surface of the aluminum sheet;
wherein:
the thermal conductivity of the aluminum sheet is equal to or greater than 150 W/m·K,
the resin-based film includes a thermosetting resin,
the film thickness of the resin-based film is 15-200 μm,
the integrated emissivity of the resin-based film in the infrared region having the wavelength of 3-30 μm is equal to or greater than 0.80 at 25° C., and
when the minimum temperature that the resin-based film reaches while the pre-coated aluminum sheet is used as a heat sink is expressed as T1° C., the glass transition temperature of the resin-based film is equal to or below T1+20° C.

2. A pre-coated aluminum sheet comprising:
an aluminum sheet; and
a resin-based film formed on the surface of the aluminum sheet;
wherein:
the thermal conductivity of the aluminum sheet is equal to or greater than 150 W/m·K,
the resin-based film includes a thermosetting resin, and
the film thickness of the resin-based film is 15-200 μm,
the integrated emissivity of the resin-based film in the infrared region having the wavelength of 3-30 μm is equal to or greater than 0.80 at 25° C., and,
when the minimum temperature that the resin-based film reaches while the pre-coated aluminum sheet is used as a heat sink is expressed as T1° C. and the maximum temperature that the resin-based film reaches while the pre-coated aluminum sheet is used as a heat sink is expressed as T2° C., the glass transition temperature of the resin-based film is {(T1+T2)/2−30}° C. to {(T1+T2)/2+30}° C.

3. The pre-coated aluminum sheet according to claim 1, wherein the glass transition temperature of the resin-based film is equal to or below 10° C.

4. The pre-coated aluminum sheet according to claim 2, wherein the glass transition temperature of the resin-based film is 10° C. to 70° C.

5. The pre-coated aluminum sheet according to claim 1, wherein the resin-based film further includes a black pigment composition.

6. The pre-coated aluminum sheet according to claim 1, wherein the film thickness of the resin-based film is 15-50 μm.

7. The pre-coated aluminum sheet according to claim 1, wherein the crystal microstructure of the aluminum sheet is fibrous.

8. A heat sink comprising:
a heat sink formed body formed of wrought aluminum and aluminum alloy sheets; and
a resin-based film formed on the surface of the heat sink formed body;
wherein:
the thermal conductivity of the wrought aluminum and aluminum alloy sheets is equal to or greater than 150 W/m·K,
the resin-based film includes a thermosetting resin,
the film thickness of the resin-based film is 15-200 μm,
the integrated emissivity of the resin-based film in the infrared region having the wavelength of 3-30 μm is equal to or greater than 0.80 at 25° C., and
when the minimum temperature that the resin-based film reaches while the heat sink is used is expressed as T1° C., the glass transition temperature of the resin-based film is equal to or below T1+20° C.

9. A heat sink comprising:
a heat sink formed body formed of wrought aluminum and aluminum alloy sheets; and
a resin-based film formed on the surface of the heat sink formed body:
wherein:
the thermal conductivity of the wrought aluminum and aluminum alloy sheets is equal to or greater than 150 W/m·K,
the resin-based film includes a thermosetting resin,
the film thickness of the resin-based film is 15-200 μm,
the integrated emissivity of the resin-based film in the infrared region having the wavelength of 3-30 μm is equal to or greater than 0.80 at 25° C., and,
when the minimum temperature that the resin-based film reaches while the heat sink is used is expressed as T1° C. and the maximum temperature that the resin-based film reaches while the heat sink is used is expressed as T2° C., the glass transition temperature of the resin-based film is {(T1+T2)/2−30}° C. to {(T1+T2)/2+30}° C.

10. The heat sink according to claim 8, wherein the glass transition temperature of the resin-based film is equal to or below 10° C.

11. The heat sink according to claim 9, wherein the glass transition temperature of the resin-based film is 10° C. to 70° C.

12. The heat sink according to claim 8, wherein the resin-based film further includes a black pigment composition.

13. The heat sink according to claim 8, wherein the film thickness of the resin-based film is 15-50 μm.

14. Onboard LED lighting comprising the pre-coated aluminum sheet according to claim 1.

15. Onboard LED lighting comprising the pre-coated aluminum sheet according to claim 2.

16. Onboard LED lighting comprising the heat sink according to claim 8.

17. Onboard LED lighting comprising the heat sink according to claim 9.
